(19) United States
(12) Patent Application Publication
(10) Pub. No.: US 2022/0357043 A1
(43) Pub. Date: Nov. 10, 2022

(54) METHOD AND SYSTEM FOR CONTROLLING AN OVEN, AND OVEN FOR HEATING FOOD ITEMS

(71) Applicant: ELECTROLUX APPLIANCES AKTIEBOLAG, Stockholm (SE)

(72) Inventor: Thorben SCHIFFLER, Rothenburg ob der Tauber (DE)

(21) Appl. No.: 17/622,171

(22) PCT Filed: Jun. 5, 2020
(86) PCT No.: PCT/EP2020/065666

§ 371 Date: Dec. 22, 2021

(30) Foreign Application Priority Data
Jun. 25, 2019 (EP) 19182177.6

(51) Int. Cl. F24C 7/08; H05B 1/02

(52) U.S. Cl. CPC F24C 7/085; H05B 1/0263

(57) ABSTRACT

The present invention relates to a computer-implemented method of controlling an oven comprising a heating chamber that spans a 3D-volume for accommodating therein one or more food items to be, respectively, heated in one of a plurality of 3D coordinate positions by a heating system, the heating system comprising multiple heating elements arranged and configured to feed, via corresponding emission areas, at least one of radiant heat, heated air, and laser radiation into the 3D-volume, wherein at least two heating elements, differ from each other in at least one of orientation and location of the emission area relative to a 3D-volume reference, the method comprising calculating an operating parameter settings for operating the oven according to a locally-based heating scheme based on a 3D coordinate location of a food item located in the heating chamber.

The present invention relates to methods and systems for controlling (a household appliance, such as) an oven, e.g. a baking oven, and oven, in particular baking oven for heating, in particular baking, food items.

Ovens for heating food items may be used for different purposes such as baking, roasting, broiling, thawing, defrosting and the like. Further, such ovens may be used for many different kinds of food.

Different uses and kinds of food respectively require different and specific modes of operation, in particular with regard to applying heat to food items placed in a heating chamber of an oven. Regarding such different and specific modes of operation, there seems to exist room for improvements with regard to applying heat to food items placed in the heating chamber.

In view of the above, it is an object of the present invention to provide improvements with regard to applying heat to food items placed in a heating chamber of an oven.

This object is, in particular, accomplished by the present invention by the embodiments of the present invention as set forth in the independent claims. Further embodiments of the invention accomplishing the underlying object are set forth in the depend-ent claims and the following description.

In an embodiment, a computer-implemented method of controlling an oven, such as a baking oven which shall be understood as an oven specifically adapted to apply a heat treatment to food items, wherein the heat treatment may be selected from the following non-exhaustive list: baking, roasting, broiling, browning, defrosting, thawing.

A respective oven comprises a heating chamber that spans a three-dimensional (3D) volume, i.e. a volume that, in the spatial domain, can be defined in a 3D space by means of a 3D coordinate system. Such a 3D coordinate system can be used and is suitable for defining or describing each point or voxel of the interior of the heating chamber, in particular of the 3D volume, in a corresponding 3D coordinate system by 3D coordinates (e.g. X, Y, and Z Cartesian coordinates, or others) representing 3D coordinate positions (e.g. X,Y,Z) of such points or voxels, for example.

The 3D volume, i.e. the heating chamber, is provided for accommodating therein one or more food items to be, respectively, heated in one of a plurality of 3D coordinate positions by a heating system. Generally, the heating system may be part of the oven, i.e. an integrated component. However, external heating systems may be envisaged.

In the context of the present invention, a food item may be considered as one of a single food object or a group of food objects, for example of same or different kind or type. A food object may have a composition involving solid and liquid food components, kinds or types and any mixtures thereof.

The heating system of the oven comprises multiple heating elements, i.e. at least a first and a second heating element. The heating elements are arranged and configured to feed (in particular: to radiate or to apply), via corresponding emission areas, at least one of radiant heat, heated air, and laser radiation into the 3D-volume.

The laser radiation may for example be based on laser radiation of a CO₂-laser and/or laser radiation in the terahertz range. Heated air may for example be generated by one or more heated air generators with emission areas implemented as air outlet ports. Heated air may also be generated by gas burners or similar devices. Radiant heat may for example be generated by solid state heating devices, infra-red (IR) heating devices, focused IR heating devices, and the like.

The at least two heating elements, differ from each other in at least one of orientation and location of the emission area relative to a 3D-volume, e.g. a 3D-volume reference. For example, the heating elements may differ from each other in the radiant or beam direction, in particular in the exit surface normal of the heating area. Further, the heating elements may differ from each other in the particular location of the emission areas, e.g. top, bottom, side, front, rear and back, relative to the heating chamber.

The method according to an embodiment of the invention comprises a step of receiving, at a processing unit, from one or more sensor units one or more sensor signal packages (in particular: ma-chine readable and processable information items), each sensor signal package comprising sensor data associated with (in particular: representative of or including) a 3D coordinate location information (e.g. machine readable and processable 3D coordinate location) of at least one food item placed (in particular: located) within the 3D-volume.

The 3D coordinate location information shall be considered as being related to real 3D coordinates requiring three coordinate variables describing a location in 3D space. Albeit an image may be considered as two-dimensional, images may be associated with 3D information for example in view of grid-based 3D data model-ling and extraction and/or by including information on a reference item or point indicating, for example, location and/or orientation in the 3D space. The same applies for other sensor signal packages, wherein associations with a 3D coordinate location may also be established by combining sensor data from same or different sensors having, for example, different sensing direc-tions and/or angles. For example, 3D coordinate location information may be extracted from two images captured from different viewing angles in combination with a reference point comprised in at least one of the images.

The sensor data may for example comprise sensor data selected from the group comprising but not limited to: image data (visi-ble light, IR light), proximity sensor data, inductive sensor data, light barrier data, reflection light barrier data, and capacitive sensor data. Suitable one or more sensor units may comprise corresponding sensors selected from, but not limited to one or more cameras, proximity sensors, capacitive sensors; inductive sensors, optical sensors, light barriers, reflection light barriers. Regarding such sensors, sensor data generated by a corresponding sensor are in particular considered as machine-readable data suitable for data processing. In particular, with regard to image data, the technical information of such sensor data is considered relevant rather than aesthetic or cognitive information content comprised by an image captured by a camera.

The method according to the embodiment comprises the further step, by the processing unit, calculating from the 3D coordinate location information (in particular: 3D location information of the at least one food item placed/located within the 3D volume of the heating chamber) a 3D coordinate location of the food item. Such 3D coordinate location information may include ma-chine readable information indicating to a computing system 3D coordinates of at least one food item in a 3D space describing the 3D volume of the heating chamber.

The method according to the embodiment comprises the further step, by the processing unit, determining (in particular: calculate, derive), based at least on part on (including, but not limited to based exclusively on) the 3D coordinate location information, at least one set of operating parameter settings, for example an initial operating parameter settings or an updated operating parameter settings in case of applying the method iteratively, for operating (in particular controlling) at least one of the multiple heating elements in accordance with a locally-based heating scheme. An operating parameter settings shall in particular mean a set of one or more operational ma-chine-readable parameters, in particular instructions, usable by a controller for controlling a heating element in accordance with the parameters.

In the locally-based heating scheme, the at least one heating element is controlled in dependence of the calculated 3D coordinate location. A locally-based heating scheme in particular shall be understood as an operational mode in which the 3D coordinate location is used as one control parameter for controlling the heating system of the oven to specifically heat the object associated with the 3D coordinate location. For example, if the 3D coordinate location indicates that a food item, such as a single food object of a group of food objects of same or different kind or type, is arranged in an upper, rear and off-center position, one or more heating elements suitable for heating an area associated with, in particular surrounding, the 3D coordinate location can be activated such the food item is specifically heated, whilst other food items located in other 3D locations outside of the area, are at least not fully exposed to the flux generated by the one or more heating elements. In other words, the locally-based scheme may be considered as a heating scheme in which the flux generated by one or more heating elements is specifically adapted (power level, type of heating medium such as heat, air, radiation) and restricted to a particular 3D area or 3D sub-volume of the 3D volume of the heating chamber.

The method according to the embodiment comprises the further step, by the processing unit, providing, e.g. transferring via a cable-bound or cable-less communication path (e.g. a network), the calculated operating parameter settings for execution of the locally-based heating scheme by a control unit of the oven. That in particular means, that the processing unit generates, based at least in part on computerized data processing of the one or more sensor signal packages, parameters specific for operating one or more respective heating elements such that the locally-based heating scheme is carried out when the oven is operated based on the parameters.

As can be seen, the proposed method provides an improved way for heating a food item placed in the heating chamber of an oven.

In an embodiment that may be combined with any other embodiment described herein, the one or more sensor signal packages comprise at least one electronic image data package comprising electronic image data of at least one of the at least one food item located within the 3D-volume. For example, the image data package may comprise one or more, e.g. two, three or more still images, or a series of video frames. The image data may for example cover at least a section of the at least one food item, and parts or sections of one or more inner walls of the heating chamber, optionally together with one or more reference items, such as a tag or something similar.

According to an embodiment, the electronic image data are captured by one or more camera units comprised by the one or more sensor units. The electronic image data comprises, in the present embodiment, as (the) 3D coordinate location information first (2D or 3D) image data of at least a section of at least one of the at least one food item, and second (2D or 3D) image data of at least one reference associated with the heating chamber. Based on such data, the processing unit calculates (in particular: determines, derives), in accordance with this embodiment, the 3D coordinate location at least in part based on the first and second image data.

The reference may be at least one of an element or component of an inner wall of the heating chamber (e.g. fan cover, illumination, grid, rack-slots, shelf-slots), a marker, label, tag, in-dentation etc. on an inner wall of the heating chamber, i.e. inner references, and/or outer references such as markers, labels, tags etc. present on an outer wall or part of the oven.

In embodiments in which the processing unit and one or more cameras are for example part of the oven (the cameras may be mounted in such a way that they can capture images form the 3D volume from different viewing angles), the method may be carried out by the oven as such and, in doing so, carry out a step of capturing, by at least one of one or more camera units, the image data, and transmitting the image data from the at least one camera unit to the processing unit. However, and as will be described in further detail below, at least some of the components like the processing unit, the camera unit, the oven and others, may belong to different entities, and respective data, such as the operating parameter settings, the image data, may be ex-changed by using cable-bound or cable-less networks.

In an embodiment involving electronic image data, the electronic image data may comprise multiple (in particular: two or more, a plurality of) images, e.g. electronic images capture for example as separate still images, or in connection with a video as multiple video frames. The multiple images may be captured from different perspectives (in particular: viewing angles), wherein, (in particular: such that) each image includes image data of the at least one food item, e.g. one or more food objects. At least one image may include at least one of the at least one reference. By this, the processing unit may calculate (in particular: determine) the 3D coordinate location by detecting the relative position of the at least one food item in the at least one image, and by evaluating and analysing the reference with regard to a relative position of the food item within the 3D volume in terms of 3D coordinate data.

In an embodiment that may be combined with any other embodiment described herein, at least one of the one or more sensor signal packages comprises, in addition to the sensor data, metadata information. The metadata information may comprise at least one of: the type of oven, the type of one or more sensors used for recording the sensor signals (e.g. the type of a camera, the type of a mobile handheld device, such as a smartphone, including a particular camera or similar hand-held devices), recording details for recording the sensor data (e.g. whether the data were recorded by an image or other sensors), a type of data, such as still image or video frame, a viewing angle, a zoom level, the location of the sensor relative to the heating chamber etc.), the type of sensor signals (e.g. image, still image, video frame, distance sensor data, capacitive sensor data, inductive sensor data etc.), a kind of food (e.g. meat, bakery, etc.), a type of food (i.e. a particular type of a kind), process information for heating the food item (e.g. the desired or preferred heating, cooking or baking process, a desired doneness level, a doneness threshold etc.). If such metadata are included, the processing unit extracts may extract one or more of the metadata for calculating the 3D coordinate information and/or or for calculating the at least one set of operating parameter settings. The metadata may be provided automatically, for example by respective sensors, or may be provided based on user inputs regarding the desired heating, cooking, or baking process. Food kind, type and similar information may be determined by the processing unit, for example based on image data and/or based on requesting corresponding user inputs or selec-tions from the user operating the oven. Using such metadata may greatly improve the speed and efficiency of the operating parameter settings determination.

In an embodiment that may be combined with any other embodiment described herein, the processing circuit is coupled, for data transmission, to a wire-less or wire-bound data transmission network (including for example one or more associated networked components, such as cloud-based components, databases, servers, clients etc.) and/or data bus. In such embodiments, the method can be implemented such that the processing circuit receives one or more of the one or more sensor signal packages via the data transmission network and/or data bus from respective one or more sensor units. Implementing cloud or network-based services may contribute to further improving the operating parameter settings determination.

In an embodiment that may be combined with any other embodiment described herein, at least one of the one or more sensor signal packages is associated with information on at least one of a shape, a volume, a surface pattern, and a temperature pattern of the food object. Such information may be advantageously used for determining the 3D coordinate location, kind, type, doneness level etc.

In an embodiment that may be combined with any other embodiment described herein, the processing circuit calculates from the information of the at least one signal package, such as the information identified beforehand, at least one of a type, kind, sort, size, volume, and 3D-subvolume of the food item within the 3D-volume.

In an embodiment that may be combined with any other embodiment described herein, the processing unit calculates the at least one set of operating parameter settings, in addition to the calculated 3D coordinate location, based on at least one of the calculated type, kind, sort, size, volume, and 3D-subvolume. Using such additional information may greatly improve the cooking or baking result as desired, for example, by the operating user, or as is adequate for a corresponding food item.

In an embodiment that may be combined with any other embodiment described herein, the steps of receiving sensor signal packages and calculating, based on an analysis of the sensor signal packages, the at least one set of operating parameter settings is carried out several times in sequence (in particular: itera-tively) during a heating process for heating the food item. For example, the method may be carried out in accordance with predetermined time intervals, which may be selected in dependence of the heating process or other conditions, such as the size of the food item, the doneness level the 3D location, the distance to a particular heating element etc. In such embodiments, the processing unit may provide, for at least one of the several times, an updated set of operating parameter settings for execution by the control unit based on a sensor signal package associated with the respective at least one time, i.e. for the sensor signal package that is used as the basis for generating the updated set. In variations, an updated set may only be provided if the subsequent signal package is indicative of a change in one or more parameters determined by the processing unit, e.g. the 3D location, volume, shape, texture, degree of browning etc. For example, an update may be provided if it is determined that a change in at least one parameter exceeds a predetermined threshold.

In an embodiment that may be combined with any other embodiment described herein, at least one of the sensor signal packages is associated with doneness information (e.g. includes, for example, browning information in an image, or temperature information, total heating time etc., for example in the form of metadata). The processing unit may calculate (in particular: extract, determine), based on the at least one sensor signal package and doneness information, at least one doneness value representative of the degree (in particular: level) of doneness of the food object. The degree of doneness may be considered as representing direct cause of the heat treatment. In such embodiments, the processing unit may calculate in dependence of (in particular: based on) the at least one doneness value one or more operating parameter updates, and may provide the one or more operating parameter updates for execution by the control unit of the oven. For example, the updates may be transmitted to the control unit, for example based on a push or pull data transfer operation.

In an embodiment that may be combined with any other embodiment described herein, the processing unit compares (for example based on a metric, such as a difference metric or a distance metric applied for example in value pairs or intervals), the calculated doneness value with a predetermined doneness threshold (for example set by the user or automatically by a predetermined heating program). In such embodiments, the processing unit may determine, based on the comparison, whether the doneness value sufficiently corresponds to the predetermined doneness threshold. If, for example, the determination yields that the doneness value sufficiently corresponds to the predetermined doneness threshold, the processing unit determines (in particular: calculates, derives) an operating stop or finishing parameter setting for stopping or finishing the locally-based heating scheme, and provides the operating stop or finishing parameter setting for execution by the control unit of the oven. An operating stop may be considered as an operational instruction imme-diately stopping the heating procedure. A finishing instruction may be considered as one or more instructions prior to the stop of the heating procedure for obtaining a desired finishing, e.g. browning etc. The finishing instruction may be followed or include a stop instruction for stopping the heating after the finishing procedure.

In an embodiment that may be combined with any other embodiment described herein, the one or more sensor signal packages (e.g. for a single food item or for two or more food items or food objects) are associated (not only with a single, but) with multiple food items (e.g. one package for a single food item, or at least one package for two or more food items). Analogously, the metadata, if any, may be associated with multiple food items.

In such embodiments, the method may comprise the step of, by the processing unit, calculating (in particular: calculate, determine, in particular determine by data processing) for two or more of the multiple food items (a food item may be a single food object or a group of two or more same/different food objects), two or more associated 3D coordinate locations. Further, in such embodiments, the method may comprise the step of, by the processing unit, determining, based at least in part on the calculated two or more associated 3D coordinate locations, for each of the associated 3D coordinate locations a corresponding operating parameter setting for controlling at least one of the heating elements to carry out a locally-based heating scheme that is, respectively, specific for the associated 3D coordinate. In other words, the processing unit may provide specific (in particular: different) locally based heating schemes for different food items, e.g. associated with different 3D coordinate locations. Yet further, in such embodiments, the method may comprise the step of, by the processing unit, providing the determined corresponding operating parameter settings for execution by the control unit of the oven to carry out (by applying the operating parameter settings), by the at least one heating element, the locally-based heating schemes for each of the associated 3D coordinate locations and related food items. In particular such embodiments may provide enhanced cooking or baking results for different food items located in the heating chamber, in particular if some of the food items require different heat treating schemes.

In an embodiment of the invention a system for operating an oven is provided. A corresponding oven may comprise, as already defined in connection with the embodiments related to the method, a heating chamber that spans a 3D-volume for accommodating therein one or more food items to be heated. Regarding the 3D-volume, the heating chamber, the food items and other elements and components already described in connection with the method shall, unless otherwise indicated have the same meaning and/or scope as defined/described in connection with the embodiments of the method.

A corresponding system may comprise at least one of the following components:
at least one processing unit that is programmed to carry out, when operated, a method according to any embodiment described herein;
a computer-readable (in particular non-transitory) storage medium comprising instructions which, when executed by a processing unit, cause the processing unit to carry out a method according to any embodiment described herein,
a computer-program product comprising computer-readable instructions that, when loaded into the memory of a processing unit cause the processing unit to carry out a method according to any embodiment described herein; and
a computer-readable signal sequence that (in particular in its entirety) is able, when loaded into the memory of a processing unit to cause the processing unit to carry out a method according to any embodiment described herein.

Respective components, e.g. the processing unit, the computer-readable storage medium, etc. may be implemented as external or internal components of a corresponding oven. For example, in case of an external implementation, a processing unit may be provided as a server device providing a service for calculating and providing operating parameter settings. Such settings may be transmitted to a control unit of the oven for execution via a cable-bound or cable-less network.

The computer-readable storage medium may for example be directed to be an internal storage of the oven, or an external storage N from which a control unit of the oven may download, e.g. over a network connection, computer executable instructions for carrying out the method.

A computer program product may for example be implemented as a downloadable program or a data carrying including computer-executable instructions that, when executed, cause a control unit of (in particular associated with) the oven to carry out the method. In this connection, it shall be noted that the control unit associated with the oven may be an internal control unit, e.g. implemented in connection with an electronic control device within the oven, or as an external control unit configured for controlling the oven via one or more data connections from a re-mote location, for example.

The computer-readable signal sequence, for example, may be considered as a downloadable computer program product transmitted, e.g. by one or more data packages, to the oven or another entity for installation on the oven.

In an embodiment of the system, that may be combined with any other embodiment of the system described herein, the system further comprises a heating system comprising multiple heating elements (e.g. heating elements arranged at the top, bottom, side, front, rear, back relative to the 3D volume, in particular as single heating elements, as combined heating elements arranged for example in an array etc.). In such embodiments, the multiple heating elements bay be arranged and configured to heat food items placed in the heating chamber. In such embodiments, the multiple (in particular: two or more) heating elements may differ from each other in at least one of orientation and location of an emission area.

Further, in such embodiments, the oven may comprise at least one of the processing unit as described above as an internal processing unit communicatively coupled to a control unit for controlling the multiple heating elements to execute a locally-based heating scheme, and a computer-readable storage medium as described above communicatively coupled to an internal processing unit such that the computer readable instructions of the storage medium can be loaded into the memory of the processing unit for execution. In particular, the oven may be implemented with all components as a standalone device, such that any of the embodiments of the method can be carried out by the oven alone. However, as indicated above, the system including for example the oven may be implemented as a distributed system, in which one or more operating components for carrying out a method according to any embodiment described herein may be implemented as separate devices interconnected via suitable network connections.

In an embodiment of the system, that may be combined with any other embodiment of the system described herein, the system may further comprise a sensor unit for generating the sensor signal packages, wherein the sensor unit is configured such that if one or more food item are placed in the 3D volume, the sensor signal packages comprise sensor data associated with a 3D coordinate location information of at least one, in embodiments of all of the one or more food items. In such embodiments, the sensor unit may comprise, for generating the sensor data, at least one of:
one or more position sensors;
one or more proximity sensors;
one or more light barrier sensors;
one or more reflex light barrier sensors;
one or more cameras.

The sensors may respectively be adapted and configured for scanning the 3D volume and/or an opening of the heating chamber to obtain the 3D location information. For example, the sensors may be mounted and be adapted such that 3D location information may be derived during inserting one or more food items into the heating chamber, or after placing the one or more food items in the heating chamber. Start of the location determination may be triggered by user activation, or automatically, for example upon opening or closing a door of the heating chamber.

In an embodiment of the system, that may be combined with any other embodiment of the system described herein, at least one of is the at least one sensor unit may be implemented as an internal sensor unit of the oven.

In an embodiment of the system, that may be combined with any other embodiment of the system described herein, at least one of the at least one sensor unit may be implemented as an external sensor unit, wherein the external sensor unit may be implemented in connection with one of a stationary sensor device, mobile sensor device and a mobile handheld sensor device. As an example, a sensor device in form of a camera may be used the camera being a camera unit comprised by a mobile device, such that a smartphone or table computing device. A corresponding device may be operated by the user to capture images, e.g. representative of a food item placed in the heating chamber, wherein the captured images (one or more still images or video frames) may be transmitted to a corresponding processing unit for determining the operating parameter settings. In embodiments, the processing unit may, at least in part, be implemented on the mobile device, for example in connection with an application installed on the mobile device. The operation parameter settings may then be transmitted to the control unit of the oven for execution. Simi-arly, the processing unit may be implemented on a server device providing a service for generating operation parameter settings. Corresponding sensor data, e.g. images, may uploaded to the server-sided service, and by the server, used for determining the operation parameter settings. The determined operation parameter settings may be provided for transfer to the control unit of the oven (push or pull data transfer) for executing a corresponding locally-based heating scheme.

In an embodiment of the system, that may be combined with any other embodiment of the system described herein, the at least one sensor unit may be configured for being communicatively coupled to a processing unit that is implemented as an internal processing unit of the oven, wherein the processing unit is configured for carrying out a method according to any embodiment described herein.

In an embodiment of the system, that may be combined with any other embodiment of the system described herein, the at least one sensor unit may be configured for being communicatively coupled with a processing unit implemented as an external processing unit of the oven, wherein the external processing unit is implemented as a server device with regard to sensor signals provided by the sensor unit acting as a client device, and wherein the server device comprises a processing unit that is implemented to carry out a method according to any embodiment described herein.

Therefore, the processing unit, the sensor unit, the control unit maybe implemented in arbitrary combination in separate devices, interconnected, as required, by a suitable data connection (e.g. a network), in particular for example in a client-server environment. For example, the processing unit may be implemented as a server-based service, in which the sensor unit acts as an uploading client entity with regard to transmitting sensor data to the server, and in which the control unit may be implemented as a downloading client entity with regard to ob-taming the operating parameter settings.

In embodiments of the invention, an oven for heating food items may be provided. Such an oven may comprise a heating chamber that spans a 3D-volume for accommodating therein one or more food items to be heated, respectively, in one of a plurality of 3D coordinate positions by a heating system. Regarding the 3D volume, the heating system and other components, reference is also made to the embodiments of the method and system describe above, which shall apply mutatis mutandis. The oven may for example be operated with regard to heat generation based on at last one of electric energy and gas.

In such an oven, the heating system may comprise multiple heating elements arranged and configured to feed, via corresponding emission areas, at least one of radiant heat, heated air, and laser radiation, or similar, into the 3D-volume, wherein at least two heating elements, differ from each other in at least one of orientation and location of the emission area relative to a 3D-volume reference. Regarding the emission areas, reference is made to the discussion in connection with the method and system, which shall apply mutatis mutandis.

Further, such an oven may comprise one or more sensor units configured for generating sensor signal packages, each sensor signal package comprising sensor data associated with a 3D coordinate location information of at least one food item placed within the 3D-volume. Regarding the sensor units, reference is made to the discussion in connection with the method and system, which shall apply mutatis mutandis.

Yet further, such an oven may comprise a processing unit communicatively coupled to the sensor units for receiving the sensor signal packages and configured to execute a method according to any embodiment described herein. Regarding the method, full reference is made to the discussion further above.

Still further, the oven may comprise a control unit for controlling the oven according to operating parameter settings for execution of a locally-based heating scheme, provided for execution by the processing unit. Regarding the locally-based heating scheme, full reference is made to the discussion further above.

In an embodiment of the oven, the oven may comprise at least one reference point or area suitable for aligning the 3D volume and a 3D coordinate system for describing the 3D volume. The reference point or area may be provided at least one of on or at an inner wall of the heating chamber and an outer wall of the oven.

The reference point or area may include at least one of a structural element of the oven (e.g. a fan grid, an illumination unit, a cover of an illumination unit), a notch, a groove, an imprint (e.g. on an inner or outer wall), a label (e.g. on an inner or outer wall), a smart label or smart tag (e.g. including computer-readable information associated with 3D coordinates within the 3D volume), and a label, imprint or tag respectively including information on at least one of oven type, spatial relationships to other reference points or areas or elements of the oven.

Based on the above discussion, the suggested method, system and oven in particular provide improvements with regard to obtaining enhanced results when heating, e.g. cooking or baking, one or more food items in a heating chamber of an oven.

The present invention will be described in further detail with reference to the drawings, in which

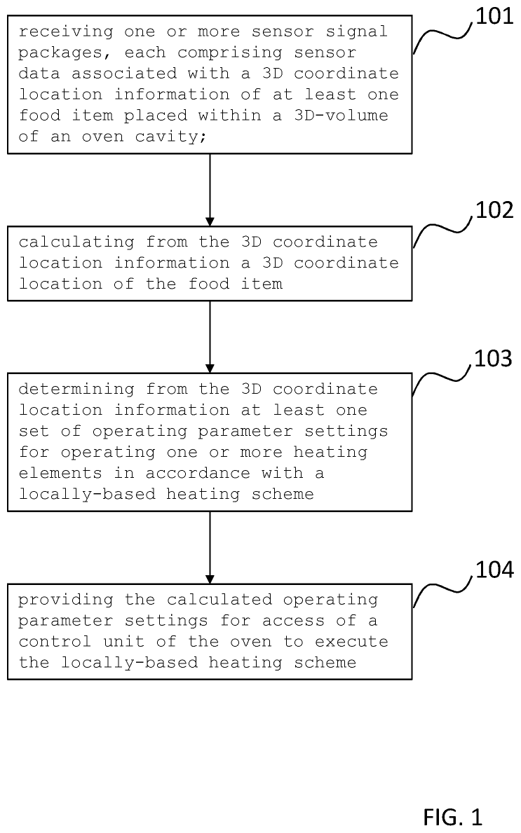

FIG. 1 illustrates a schematic process diagram of an exemplary embodiment of a method according to the invention;

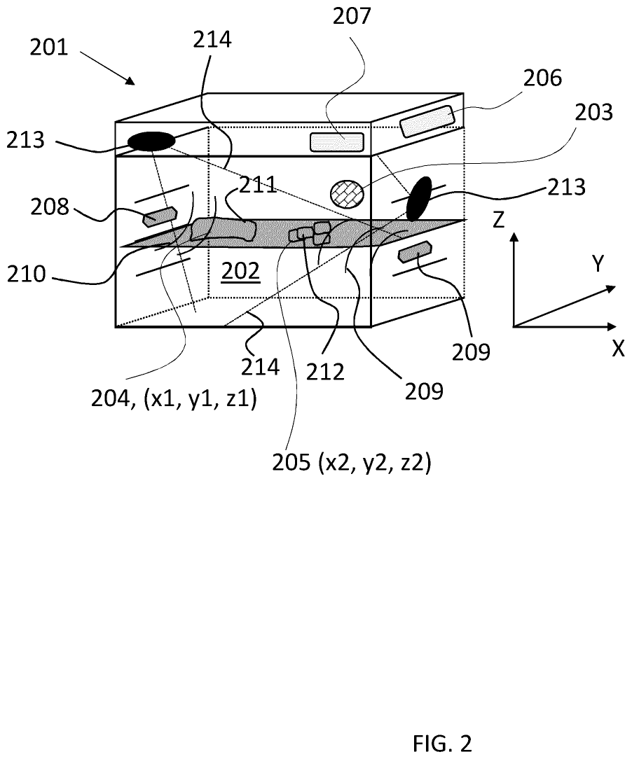

FIG. 2 illustrates a schematic configuration of a cooking oven based on an exemplary embodiment of the invention;

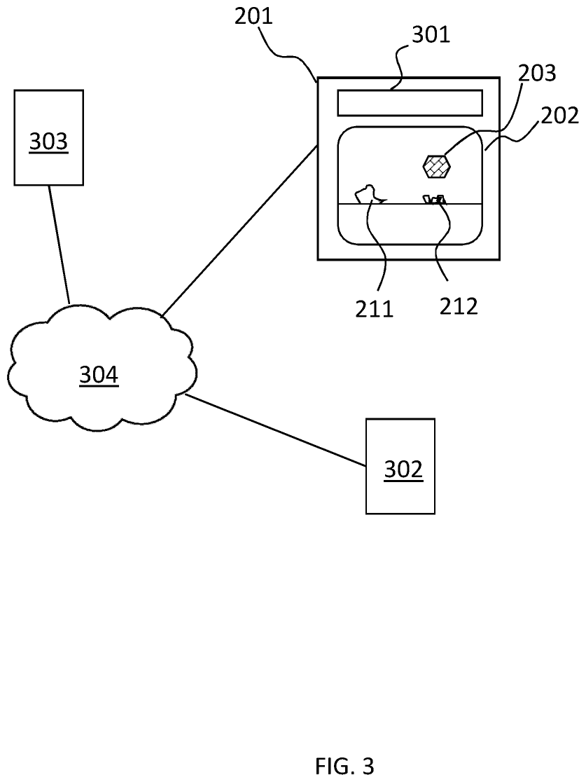

FIG. 3 illustrates a schematic configuration of a system based on an exemplary embodiment of the invention; and

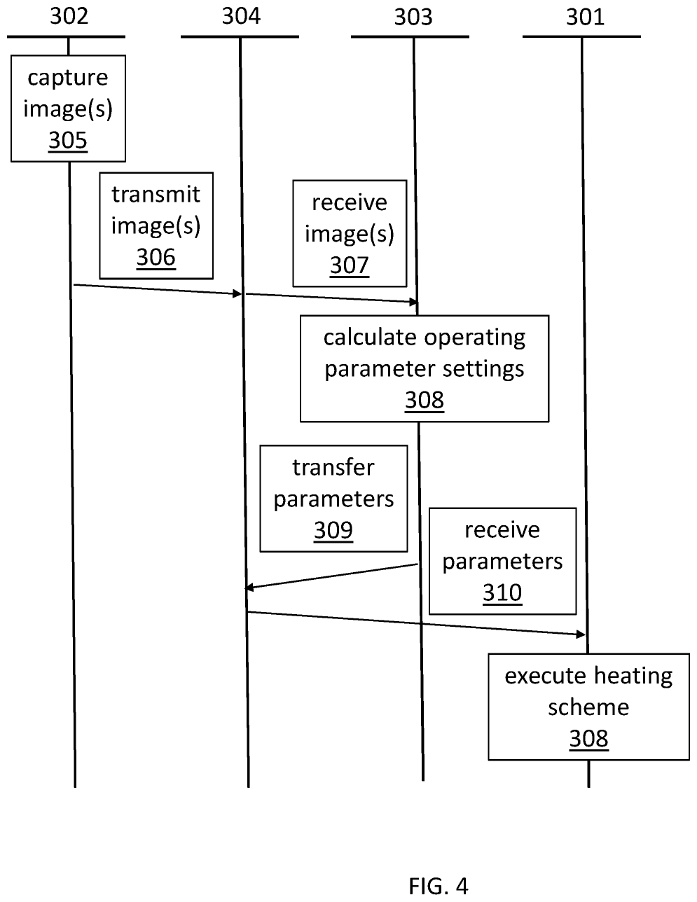

FIG. 4 illustrates a schematic operational diagram of one exemplary embodiment.

FIG. 1 illustrates a schematic process diagram of an exemplary embodiment of a method according to the invention.

In a first step 101, a processing unit, for example of an oven or of entity external to the oven, receives one or more sensor signal packages. Each of the sensor signal packages comprises sensor data associated with a 3D coordinate location information of at least one food item placed within a 3D-volume of a baking or cooking oven cavity.

In a subsequent step 102, the processing unit calculates a 3D coordinate location of the food item from the 3D coordinate location information. The 3D coordinate location corresponds, in the given example, to a particular 3D position of the at least one food item in a heating chamber of the oven spanning a 3D volume.

In a further subsequent step, the processing unit determines from the 3D coordinate location information at least one set of operating parameter settings for operating one or more heating elements of the oven in accordance with a locally-based heating scheme.

In a yet further operational step, the calculated operating parameter settings is provided for access, e.g. download or data transfer, such that a control unit of the oven is able, by implementing the operating parameter settings, to execute the locally-based heating scheme, i.e. to heat the one or more food items in dependency of their position within the 3D volume.

This in particular means that the processing unit is able to determine a suitable locally-based heating scheme, suitable for being applied to the food item positioned in the determined 3D location. Such a locally-based heating scheme may improve the overall heating, e.g. baking or cooking, process for a food item.

FIG. 2 illustrates a schematic configuration of a baking oven 201 based on an exemplary embodiment of the invention. The cooking (baking) oven comprises a baking chamber 202 spanning a 3D volume in a 3D space including an x, y, and a z coordinate system relative to a coordinate reference 203.

In the baking chamber 202, there are two food items, a first food item 204 and a second food item 205. One of the food items 204 is a single food item of a particular type, and the other food 205 item comprises a plurality of food items of a different type.

The first food item is located in a first 3D location (x1, y1, z1), and the second food items are located in a second 3D location (x2, y2, z2).

A processing unit 206 and a control unit 207 are arranged in an upper control section of the baking oven 201, wherein the processing unit 206 is configured for determining the operating parameter settings for execution by the control unit to perform the locally-based heating scheme for each of the 3D coordinate locations 204, 205.

In the exemplary embodiment of FIG. 2, two heating elements 208 and 209 are provided and configured for applying locally-based heat radiation 210 to a respective food item 211, 212 arranged nearby.

The baking oven 201 comprises, as an example, two cameras 213 as sensor units for capturing images of different viewing angles 214 of the food items 211, 212 located in the baking chamber 202.

As discussed in connection with FIG. 1, the images captured by the cameras 213 may be processed, and a 3D location for each of the food items 211, 212 may be determined (calculated) by the processing unit 206. The processing unit 206 may receive respective image data from the cameras 213 via a data communication bus (not shown), or a wire-bound or wireless data communication (not shown).

Based on the images, the processing unit 206 determines an operating parameter set to be provided to the control unit 207 communicatively coupled to the heating elements 208 and 209 for executing the operating parameter set for executing the locally-based baking scheme for each of the food items 211 and 212. The heating elements may for example comprise single heaters, such as solid state heaters, hot air outlets, infra-red heaters, laser emitters, gas burners, or, the heating elements or at least one of the heating elements may comprise an array of heaters as mentioned beforehand, wherein the array may include heaters of same or different type.

In the given exemplary embodiment, all components, in particular for controlling the baking oven 201 are internal components of the baking oven 201. FIG. 3, however, shows an exemplary embodiment with a scheme for implementing corresponding components in a distributed device and communication arrangement. In particular, FIG. 3 illustrates a schematic configuration of a system based on an exemplary embodiment of the invention.

FIG. 3 illustrates a baking oven 201 comprising a baking chamber 202 with first and second food items 211 and 212 arranged in the baking chamber 202. The baking oven 201 comprises a control unit, which is schematically illustrated and depicted with reference sign 301.

FIG. 3 schematically further illustrates a camera device 302 and a processing unit 303. The baking oven 201, in particular the control unit 301, the camera device 302, and the processing unit 303 are, with regard to electronic data communication, communicatively coupled via network 304.

In operation, which is schematically illustrated in the diagram of FIG. 4, if, for example a user, inserts the food items 211, 212 into the baking chamber 202, for example placed on a baking tray, and wants to start a cooking process, the initialization and start-up procedure for the cooking process may involve the following.

The camera 302, which may for example be implemented in a handheld device, such as a smartphone or tablet, may be operated to capture 305 two or more images from the food items 211 and 212 located in the baking chamber 202. The camera 302 may for example operated by the user, or automatically from an external position. The images are captured such that they include 3D location information of the food items 211, 212 relative to the baking chamber 202. Such a 3D location information may for example be obtained by capturing an image from the food items 211, 212 such that the image also includes sections of the baking oven 201, specifically of the inner walls of the baking chamber 202, as well as a coordinate reference 203 such as a marker, tag and the like. As a coordinate reference, a grid of a fan or similar elements within the baking chamber 202 may be used.

The camera 302, or associated device, may then transmit 306 the images 306 via network 304 to the processing unit 303. The processing unit 303 then receives 307 the images and carries out a method as described in connection with FIG. 1, in which the images are analysed and an operating parameter settings for executing a locally-based heating scheme for execution by the control unit 301 is calculated 308. After calculating 308 the operational parameter setting, the operational parameter settings is transferred 309 via the network 304 to the control unit 301. The control unit 301 receives 310 the operational parameter settings (abbreviated by “parameters” in FIG. 4 for better readability), and executes a locally-based heating scheme, in which the food items 211, 212 are locally heated by one of the heating elements, such that the local temperature obtained during heating corresponds to a temperature specific for the respective food item.

As has been noted, the data transmissions between the components may be carried out over a network. However, if one or more of the components, e.g. the camera(s) and the processing unit(s) are integrated in the baking oven, data transmission may be carried out via data transmission lines.

The scheme as illustrated in FIG. 4 may be carried out several times during a heating procedure, wherein a subsequent calculated operating parameter settings may be used for updating a previously received operating parameter settings. Further, subsequent images may be used to determine a level of doneness, and if it is determined that the level of doneness substantially corresponds to the desired level of doneness, the processing unit may generate operating parameter settings for stopping or finishing the heating procedure.

Within this scheme, the processing unit 303 may for example send a request to the camera 302 to capture one or more images associated or including 3D coordinate location information on the food item(s) placed in the cooking chamber 202. In an alterna-tive embodiment, the images (and other sensor signals) may be captured automatically, for example during, upon, or after closing the oven door (not shown in the figures), or upon receiving an activation signal, for example from the user pressing a “start” button.

After receiving the image(s) and before calculating the operating parameter settings, the processing unit 303 may determine whether or not the received image(s) are suitable for determining a 3D coordinate location of the food item(s) included in the images. Such a check may be carried out also in case of using other parameters. For example, the processing unit may check whether a sufficiently large area of the baking chamber is included, and/or whether or not a coordinate reference 203 is included. The processing unit 303 in particular may also check whether or not a food item can be identified. If one or more of such preliminary checks fail, the processing unit 303 may send a further request to the camera to provide further images (or in case of using other sensors, further sensor data). The processing unit may also send a request to the user to provide a selection of a kind of food etc. Such information, and other information, may be added to an image as metadata as described further above. However, such information may also be transmitted separately from the images.

In case of a successful determination of a locally-based heating scheme, the processing unit may transmit or transfer 309 corresponding operating parameter settings to the control unit 301 for execution. Before executing the locally-based heating scheme, or before transmitting the scheme to the control unit 301, a plausibility check may be carried out. For example, the control unit 301 or the processing unit 303 may send a confirmation request to a user interface (not shown), and in case of receiving a positive confirmation, the scheme may be transmitted for execution and/or executed. In case of a negative confirmation, the scheme as illustrated in FIG. 4 (or parts thereof) may be carried out anew, wherein the processing unit 303 of the control unit 301, may, before carrying out the scheme as illustrated in FIG. 4 (or parts thereof), send a confirmation request to a user interface. In case of receiving a positive or negative confirmation, the scheme of FIG. 4 (or parts thereof) may or may not be carried out anew.

Although illustrative embodiments of the present invention have been described herein with reference to the accompanying figures, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the ap-pended claims. In particular, features described in connection with specific embodiments described in connection with the figures may be applied to and combined with any other embodiment described herein, and vice versa.

### LIST OF REFERENCE NUMERALS

101-104 operational steps
201 baking oven
202 baking chamber
203 coordinate reference
204, 205 first and second food items
206 processing unit
207 control unit
208, 209 heating element
210 heat radiation
211, 212 food items
213 camera
214 viewing angle
301 control unit
302 camera device
303 processing unit
304 network
305 capture images
306 transmit images via network
307 receive images from network
308 calculate operating parameter settings
309 transfer parameters
310 receive parameters
311 execute locally-based heating scheme
X, y, z 3D coordinate location

1. A computer-implemented method of controlling an oven comprising a heating chamber that spans a 3D-volume for accommodating therein one or more food items to be, respectively, heated in one of a plurality of 3D coordinate positions by a heating system, the heating system comprising multiple heating elements arranged and configured to feed, via corresponding emission areas, at least one of radiant heat, heated air, or laser radiation into the 3D-volume, wherein at least two of said heating elements differ from each other in at least one of orientation and location of their corresponding emission areas relative to a 3D-volume reference, the method comprising:
receiving, at a processing unit, from one or more sensor units one or more sensor signal packages, each sensor signal package comprising sensor data associated with a 3D coordinate location information of at least one food item placed within the 3D-volume;
by the processing unit, calculating from the 3D coordinate location information a 3D coordinate location of the at least one food item,
by the processing unit, determining, based at least in part on the 3D coordinate location information, at least one set of operating parameter settings for operating at least one of the multiple heating elements in accordance with a locally-based heating scheme in which the at least one heating element is controlled in dependence of the calculated 3D coordinate location; and
by the processing unit, providing the operating parameter settings for execution of the locally-based heating scheme by a control unit of the oven.

2. The method according to claim 1, wherein the one or more sensor signal packages comprise at least one electronic image data package comprising electronic image data of the at least one food item located within the 3D-volume, the electronic image data being captured by one or more camera units comprised by the one or more sensor units, wherein the electronic image data comprises as 3D coordinate location information first image data of at least a section of the at least one food item, and second image data of at least one reference associated with the heating chamber, wherein the processing unit calculates the 3D coordinate location at least in part based on the first image data and the second image data.

3. The method of claim 2, wherein the electronic image data comprises multiple images captured from different perspectives, wherein each said image includes image data of the at least one food item and at least one said image includes at least one of the at least one reference.

4. The method of claim 1, wherein at least one of the one or more sensor signal packages comprises, in addition to the sensor data, metadata information comprising at least one of: the type of oven, the type of one or more sensors used for recording the sensor signals, recording details for recording the sensor data, the type of sensor signals, a kind of food, a type of food, process information for heating the at least one food item, and wherein the processing unit extracts one or more of the metadata for calculating the 3D coordinate information and/or or for calculating the at least one set of operating parameter settings.

5. The method of claim 1, wherein the processing unit is coupled, for data transmission, to a wire-less or wire-bound data transmission network and/or data bus, and wherein the processing unit receives one or more of the one or more sensor signal packages via the data transmission network and/or data bus from respective one or more sensor units.

6. The method of claim 1, wherein:
at least one of the one or more sensor signal packages is associated with information on at least one of a shape, a volume, a surface pattern, and a temperature pattern of the food item,
the processing unit calculates from the information of the at least one signal package, at least one of a type, kind, sort, size, volume, and 3D-subvolume of the at least one food item within the 3D-volume, and
the processing unit calculates the at least one set of operating parameter settings, in addition to the calculated 3D coordinate location, based on at least one of the calculated type, kind, sort, size, volume, and 3D-subvolume.

7. The method of claim 1, wherein the steps of receiving sensor signal packages and determining the sensor signal packages, the at least one set of operating parameter settings is carried out several times in sequence during a heating process for heating the at least one food item, and wherein the processing unit provides, for at least one of the several times, an updated set of operating parameter settings for execution by the control unit based on a sensor signal package associated with said at least one of the several times.

8. The method according claim 1, wherein at least one of the sensor signal packages is associated with doneness information, and the processing unit calculates, based on the at least one of the sensor signal packages and the doneness information, at least one doneness value representative of a degree of doneness of the food item, wherein the processing unit calculates in dependence of the at least one doneness value one or more operating parameter updates, and provides the one or more operating parameter updates for execution by the control unit of the oven.

9. The method of claim 8, wherein the processing unit compares the calculated at least one doneness value with a predetermined doneness threshold, and determines, based on the comparison, whether the at least one doneness value sufficiently corresponds to the predetermined doneness threshold, wherein, if the determination yields that the at least one doneness value sufficiently corresponds to the predetermined doneness threshold, the processing unit determines an operating stop or finishing parameter setting for stopping or finishing the locally-based heating scheme, and provides the operating stop or finishing parameter setting for execution by the control unit of the oven.

10. The method of claim 1, wherein the one or more sensor signal packages are associated with multiple food items of the at least one food item, and wherein the method further comprises, by the processing unit:
Calculating for two or more of the multiple food items, two or more associated 3D coordinate locations, and,
determining, based at least in part on the calculated two or more associated 3D coordinate locations, for each of the associated 3D coordinate locations a corresponding operating parameter setting for controlling at least one of the heating elements to carry out a locally-based heating scheme that is, respectively, specific for the associated 3D coordinate, and
providing the determined corresponding operating parameter settings for execution by the control unit of the oven to carry out, by the at least one heating element, the locally-based heating schemes for each of the associated 3D coordinate locations and related food items.

11. A system for operating an oven, the oven comprising a heating chamber that spans a 3D-volume for accommodating therein one or more food items to be heated, the system comprising at least one of:
a processing unit that is programmed to carry out, when operated, the method of claim 1,
a computer-readable storage medium comprising instructions which, when executed by the processing unit, cause the processing unit to carry out said method, a computer-program product comprising computer-readable instructions that, when loaded into the memory of a processing unit cause the processing unit to carry out the method according to claim 1, and
a computer-readable signal sequence that is able, when loaded into the memory of a processing unit to cause the processing unit to carry out the method according to claim 1.

12. The system according to claim 11, further comprising said heating system, the multiple heating elements thereof differing from each other in at least one of orientation and location of the corresponding emission areas, wherein the oven comprises at least one of:
said processing unit as an internal processing unit communicatively coupled to said control unit for controlling the multiple heating elements to execute said locally-based heating scheme; and
said computer-readable storage medium communicatively coupled to an internal processing unit such that the computer readable instructions of the storage medium can be loaded into the memory of the processing unit for execution.

13. The system according to claim 11, further comprising said one or more sensor units for generating the sensor signal packages, wherein at least one of the one or more sensor units is configured such that if one or more said food items are placed in the 3D volume, the sensor signal packages comprise sensor data associated with a 3D coordinate location information of at least one of the one or more food items, wherein the one or more sensor units comprises, for generating the sensor data, at least one of:
one or more position sensors;
one or more proximity sensors;
one or more light barrier sensors;
one or more reflex light barrier sensors;
one or more cameras,
respectively adapted and configured for scanning the 3D volume and/or an opening of the heating chamber to obtain the 3D location information.

14. The system according to claim 13, wherein:
said at least one of the one or more sensor is implemented as an internal sensor unit of the oven, or
said at least one of the one or more sensor units is implemented as an external sensor unit, wherein the external sensor unit is implemented in connection with one of a stationary sensor device, a mobile sensor device or a mobile handheld sensor device.

15. The system according to claim 12, wherein
the at least one of the one or more sensor units is configured for being communicatively coupled to said processing unit which is implemented as an internal processing unit of the oven, or
the at least one of the one or more sensor units is configured for being communicatively coupled with said processing unit which is implemented as an external processing unit of the oven, wherein the external processing unit is implemented as a server device with regard to sensor signals provided by the at least one of the one or more sensor units acting as a client device.

16. Oven comprising
a heating chamber that spans a 3D-volume for accommodating therein one or more food items to be, respectively, heated in one of a plurality of 3D coordinate positions by a heating system, the heating system comprising multiple heating elements arranged and configured to feed, via corresponding emission areas, at least one of radiant heat, heated air, or laser radiation into the 3D-volume, wherein at least two of said heating elements differ from each other in at least one of orientation and location of their corresponding emission areas relative to a 3D-volume reference;
one or more sensor units configured for generating sensor signal packages, each sensor signal package comprising sensor data associated with a 3D coordinate location information of at least one food item placed within the 3D-volume;
a processing unit communicatively coupled to the one or more sensor units for receiving the sensor signal packages and configured to determine based at least in part on 3D coordinate location information associated with said sensor signal packages at least one set of operating parameter settings for operating at least one of the multiple heating elements in accordance with a locally-based heating scheme in which at least one of said heating elements is controlled in dependence of the calculated 3D coordinate location information; and
a control unit configured to control the oven according to the operating parameter settings for execution of said locally-based heating scheme that are determined by the processing unit.

17. Oven according to claim 16 further comprising at least one reference point or area suitable for aligning the 3D volume and a 3D coordinate system for describing the 3D volume, wherein the reference point or area is provided at least one of on or at an inner wall of the heating chamber and an outer wall of the oven, and wherein the reference point or area includes at least one of a structural element of the oven, a notch, a groove, an imprint, a label, a smart label or smart tag, and a label, imprint or tag respectively including information on at least one of oven type, spatial relationships to other reference points or areas or elements of the oven.

18. A method of cooking food in an oven appliance, the oven appliance comprising an oven cavity defining a 3D volume and a plurality of heating elements adapted to supply heat to the oven cavity, said heating elements differing from one another in location, orientation, mode of heating, and/or their respective heat-flux profiles relative to said 3D volume, the method comprising with respect to a first food item to be cooked within the oven cavity:
(a) obtaining a first set of a first plurality of sensor signal packages, the first plurality of sensor signal packages collectively comprising first 3D location data from different perspectives relating to a location of the first food item within said 3D volume;
(b) calculating from said first 3D location data a first 3D coordinate location of the first food item in said 3D volume;
(c) based on said first 3D coordinate location, determining a first set of operational parameter settings for operating at one of said plurality of heating elements to cook said first food item according to a first locally-based heating scheme tailored to the first 3D coordinate location within said 3D volume; and
(d) operating said oven appliance to cook said first food item according to said first locally-based heating scheme.

19. The method according to claim 18, said first 3D location data further comprising metadata that comprises a doneness value that relates to a degree of doneness of the first, the method further comprising comparing said doneness value to a predetermined doneness threshold, and:
(e) when the doneness value fails to at least meet the predetermined doneness threshold, obtaining from said first and second sensors a subsequent set of the first plurality of sensor signal packages at a subsequent point in time from the preceding set thereof, and re-comparing the doneness value from said subsequent set to the predetermined doneness threshold;
(f) when the doneness value meets or exceeds the predetermined doneness threshold, determining a stop or finishing parameter setting and implementing the same as part of the first locally-based heating scheme; and
(g) repeating steps (e) at successive time intervals until the doneness value meets or exceeds the predetermined doneness threshold.

20. The method according to claim 18, further comprising with respect to a second food item to be cooked within the oven cavity:
(a.1) obtaining from said first and second sensors a second plurality of sensor signal packages collectively comprising second 3D location data from said different perspectives relating to a location of the second food item within said 3D volume;
(b.1) calculating from said second 3D location data a second 3D coordinate location of the second food item in said 3D volume;
(c.1) based on said second 3D coordinate location, determining a second set of operational parameter settings for operating at least one of said plurality of heating elements to cook said second food item according to a second locally-based heating scheme tailored to the second 3D coordinate location within said 3D volume; and
(d.1) operating said oven appliance to cook said second food item according to said second locally-based heating scheme;
wherein the first and second locally-based heating schemes are executed concurrently, to concurrently cook both the first and second food items within the oven cavity according to their respective heating schemes;
and wherein the first and second food items are different from one another.

21. The method according to claim 18, said first plurality of sensor signal packages comprising images obtained from a camera external to said oven appliance, each said image capturing the first food item as well as a coordinate reference within said oven cavity, wherein said first 3D coordinate location is calculated by comparing relative positions of the first food item and the coordinate reference among different ones of said images.
